(19) United States
(12) Patent Application Publication
(10) Pub. No.: US 2022/0092467 A1
(43) Pub. Date: Mar. 24, 2022

(54) Control Method and Computer System Using the Same

(71) Applicant: Libgirl Co., Ltd., Taipei City (TW)

(72) Inventors: Shih-Hao Hsu, New Taipei City (TW); Shih-Chia Chen, New Taipei City (TW)

(21) Appl. No.: 17/027,659

(22) Filed: Sep. 21, 2020

(51) Int. Cl. G06N 20/00; G06K 9/62

(52) U.S. Cl. CPC G06N 20/00; G06K 9/6256

(57) ABSTRACT

A control method, applied to a single-input-single-output model, wherein at least one input port of the single-input-single-output model is configured to receive an input signal, and at least one output port of the single-input-single-output model is configured to transmit an output signal, the control method comprises receiving a plurality of input information from a dataset or an interface; generating a plurality of input signals to the single-input-single-output model according to the plurality of input information; transmitting the plurality of input signals to the at least one input port; and obtaining a plurality of output signals from the at least one output port; wherein each of the plurality of input signals is in a first predetermined data structure, and each of the plurality of input information is in a first variable data structure; wherein each of the plurality of output signals is in a second predetermined data structure.

### BACKGROUND OF THE INVENTION

### 1. Field of the Invention

The present invention relates to a control method and a computer system using the same, and more particularly, to a control method and a computer system capable of packaging single-input-single-output computing models into flexible-turns-of-inference algorithms, which make it possible to perform inference in a flexible number of turns and an interruptible manner.

### 2. Description of the Prior Art

With the development of machine learning, including but not limited to neural networks, rule-based learning, statistical modeling, or instance-based learning artificial intelligence may be applied to applications such as object detection, image recognition, voice recognition, medical diagnosis, and self-driving cars. Inference refers to inputting data into a computing model, after a series of internal calculations, and finally obtaining the inference result of the computing model. In order to obtain an appropriate machine learning model, the parameters needs to be trained first, so that the model can generate appropriate inference results based on input data and parameters, such as the surrounding environment, to achieve the above application.

Current machine learning models may be trained to calculate and update the parameters thereof with a plurality of inference data in a predetermined data structure reduces flexibility and portability, that is, the low portability. For example, the machine learning models may get the input signal with a fixed data structure, perform computation with fixed steps, and produce the output signal with a fixed data structure. As such, the input/output signal data structures are predetermined and fixed, which reduces flexibility. However, in practical scenarios, the size of input or output may vary significantly, so conversions from the variable-size inputs/outputs to the fixed-size data take place, which may induce loss of information on large inputs/outputs or spend unnecessarily long computing time on small inputs/outputs. In addition, by the approaches of conversion, the inference procedure cannot be interrupted until processing of the previous input is completed, while in some cases the best action of a service may be making responses immediately by processing only the beginning of the input rather than making delayed responses after processing the whole input. Therefore, the prior art technique with fixed I/O data structure also degrades user experiences.

Therefore, it is necessary to improve the prior art.

### SUMMARY OF THE INVENTION

It is therefore a primary objective of the present application to provide a control method and computer system for computing model inference, to improve over disadvantages of the prior art.

An embodiment of the present invention discloses a control method, applied to a single-input-single-output model, wherein at least one input port of the single-input-single-output model is configured to receive an input signal, and at least one output port of the single-input-single-output model is configured to transmit an output signal, the control method comprises receiving a plurality of input information from a dataset or an interface; generating a plurality of input signals to the single-input-single-output model according to the plurality of input information; transmitting the plurality of input signals to the at least one input port; and obtaining a plurality of output signals from the at least one output port; wherein each of the plurality of input signals transmitted to the at least one input port is in a first predetermined data structure, and each of the plurality of input information is in a first variable data structure; wherein each of the plurality of output signals obtained from the at least one output port is in a second predetermined data structure.

An embodiment of the present invention further discloses an inference method, applied to a single-input-single-output model, wherein at least one input port of the single-input-single-output model is configured to receive an input signal, and at least one output port of the single-input-single-output model is configured to transmit an output signal, the inference method comprises adding at least one auxiliary node when the inference method starts; transmitting a plurality of input signals to the at least one input port; determining a value of the at least one auxiliary node according to the output signal; and determining whether the inference method needs to stop or not according to the auxiliary node; wherein the output signal transmitted from the at least one output port is in a first variable data structure; wherein each of the plurality of input signals transmitted to the at least one input port is in a second variable data structure.

An embodiment of the present invention further discloses a computer system, applied to a single-input-single-output model, wherein at least one input port of the single-input-single-output model is configured to receive an input signal, and at least one output port of the single-input-single-output model is configured to transmit an output signal, comprises a processing unit; and a storage unit, storing a program code, wherein the program code instructs the processing unit to execute the following steps: receiving a plurality of input information from a dataset or an interface; generating a plurality of input signals to the single-input-single-output model according to the plurality of input information; transmitting the plurality of input signals to the at least one input port; and obtaining a plurality of output signals from the at least one output port; wherein each of the plurality of input signals transmitted to the at least one input port is in a first predetermined data structure, and each of the plurality of input information is in a first variable data structure; wherein each of the plurality of output signals obtained from the at least one output port is in a second predetermined data structure.

An embodiment of the present invention further discloses a computer system for an inference method, applied to a single-input-single-output model, wherein at least one input port of the single-input-single-output model is configured to receive an input signal, and at least one output port of the single-input-single-output model is configured to transmit an output signal, comprises a processing unit; and a storage unit, storing a program code, wherein the program code instructs the processing unit to execute the following steps: adding an auxiliary node when the inference method starts; transmitting a plurality of input signals to the at least one input port; determining a value of the at least one auxiliary node according to the output signal; and determining whether the inference method needs to stop or not according to the inference node; wherein the output signal transmitted from the at least one output port is in a first variable data structure; wherein each of the plurality of input signals transmitted to the at least one input port is in a second variable data structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a control method for a single-input-single-output machine learning model according to an embodiment of the present invention.

FIG. 2 is a schematic diagram of a control process for a single-input-single-output machine learning model training according to an embodiment of the present invention.

FIG. 3 is a schematic diagram of a control process for a single-input-single-output machine learning model training according to an embodiment of the present invention.

FIG. 4 is a schematic diagram of a computer system according to an embodiment of the present invention.

FIG. 5 is a schematic diagram of a computer system according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection or through an indirect electrical connection via other devices and connections.

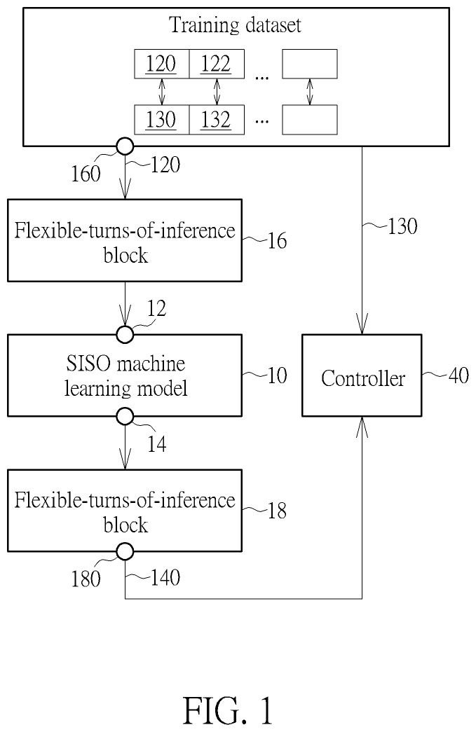

FIG. 1 is a schematic diagram of a control method for a single-input-single-output (SISO) computing model 10 according to an embodiment of the present invention. The SISO computing model 10 receives an input signal, which is converted by a flexible-turns-of-inference block 16 from an input information 120, and outputs a corresponding output signal to a flexible-turns-of-inference block 18 through an output interface 14 to generate an output information 140. The input/output interfaces 12 and 14 may comprise at least one input/output port, which are configured to receive/transmit data. The flexible-turns-of-inference blocks 16/18 are configured to queue and convert signals for the SISO computing model 10; for example, the flexible-turns-of-inference blocks 16 and 18 may convert fixed data structures of the input/output signal from/to a specific data structure, to fit requirements of the SISO computing model 10. The SISO computing model 10 is configured to learn a particular relationship between the input information 120 and the corresponding output information 140, to generate an inference function that may be applied to map new input signal in practical applications. Note that, there are a plurality of sets of input information and corresponding golden output information, such as 120 and 130, 122 and 132, . . . , in the training dataset under the particular relationship. In addition, a controller 40 is coupled between the flexible-turns-of-inference block 18 and the training dataset, and is configured to compare the output information 140 and the golden output information 130, to control the training epochs or hyper parameters. Notably, the controller 40 may be removed when the SISO computing model 10 is under normal operation. In other words, FIG. 1 stated in the above is utilized for illustrating the concept of the operation of the SISO computing model 10 and the flexible-turns-of-inference blocks 16 and 18.

However, the training dataset is used when the computing model 10 is in learning. In practical applications, the input information 120 is also sent in and out by I/O. The difference from training is that the input information 120 is provided by the user or the environment instead of the training dataset. In the following detailed description of the invention, reference is made to the accompanying drawings which form a part hereof, and in which is shown, by way of illustration. These embodiments are described in sufficient detail to enable those skilled in the art to practice the invention. Other embodiments may be utilized and structural, logical, and electrical changes may be made without departing from the scope of the present invention. For example, although the source of the input information in FIG. 1 is the training dataset, the training dataset can be replaced with the provider of the input information 120, such as a user interface. As long as the input information is entered from the I/O, the embodiment is within the scope of the present application.

For example, in a robotic system for drawing characters, a dataset thereof may comprise a plurality of control signals to train a robotic arm to draw characters in a library, such that the robotic arm may draw characters on papers. Thus, the data structures of the input information 120 and the corresponding golden output information 130 stored in the training dataset may not be the same as the requirements of the input/output interfaces 12 and 14. In the following description, data stored in the training dataset is called input/output information, to distinguish the input/output signal of the SISO computing model 10 from the dataset. In other words, each of the plurality of input/output signals transmitted to the at least one input/output port is in a first/second predetermined data structure, and each of the plurality of input/output information is in a first/second variable data structure.

However, the dataset may be removed after training such that the SISO computing model 10 may make the inference by itself. In other words, the input information 120 and output information 140 may be transmitted/received via the global I/O of the whole system.

To save the operation time and handle inputs and outputs of theoretically unlimited sizes, the present invention provides a control method and a computer system capable of packaging single-input-single-output computing models into flexible-turns-of-inference algorithms, which make it possible to perform inference in a flexible number of turns and an interruptible manner. More specifically, the present invention packages any SISO machine learning model into multiple-inputs-multiple-outputs (MIMO) models to perform flexible and interruptible inference, which has better computing efficiency and better user experiences.

For example, the flexible-turns-of-inference block 16 may make all the changes to the input/output interfaces, for example, messages from a user or a chatbot as a sequence of tokens of letters and symbols. The flexible-turns-of-inference block 16 collects the input information 120 of the SISO computing model 10, converts the input information 120 to the data structure which fits the SISO computing model 10, and triggers the SISO computing model 10 to run a computing step to calculate and infer until there's no unprocessed tokens. In addition, the SISO computing model 10 may be replaced with any SISO machine learning model with an interface containing a subset of the input/output signals, even if the data structures of the input/output interfaces are different. In other words, the present invention has flexibility in use. In addition, the user may suspend the input information anytime, and the procedure under running will not be interrupted because the FTOI blocks 16 and 18 may determine the operation for the status of I/O each time slot.

In addition, to accelerate the operation, an embodiment of the present invention may adjust or bypass to select an appropriate subset of the plurality of input information from the dataset according to the plurality of output information. For example, Chinese characters will not be used in a chatbot of English service; therefore, the embodiment may not choose those data concerning to the Chinese characters. Notably, each of the plurality of output information may be in a variable data structure, which may not be the same as the input information. Another embodiment may adjust the plurality of input information from the I/O according to both of the plurality of output information and the plurality of input information. For example, an AI grammar checker may coedit a document with human to check and correct the typo or grammar errors, and the AI grammar checker may determine each paragraph according to the plurality of input information by human and the plurality of output information generated by itself. In other words, the currently output information is the input information in the next time slot.

Similarly, if the SISO computing model 10 is applied to an voice assistant, an vowel i in phonetic notation of the International Phonetic Alphabet (IPA) may be combined with different consonants between Spanish and Modern standard Arabic when the SISO computing model 10 is under the operation, so the embodiment may generate the different input signals from the input information 120 according to the different situations. In another embodiment, the FIFO blocks 16 and 18 may correct the typo such as plural of the nouns, the case of the proper noun when the SISO computing model 10 is applied to a grammar checker.

Moreover, in an embodiment, the control method may be stopped if the performance of the SISO computing model 10 is good enough. In other words, to prevent over-fitting or over-training phenomenon, several techniques are available (e.g. model comparison, cross-validation, regularization, early stopping, pruning, Bayesian priors, or dropout). The basis of some techniques may be either (1) to explicitly penalize overly complex models or (2) to test the model's ability to generalize by evaluating its performance on a set of data not used for training, which is assumed to approximate the typical unseen data that a model will encounter.

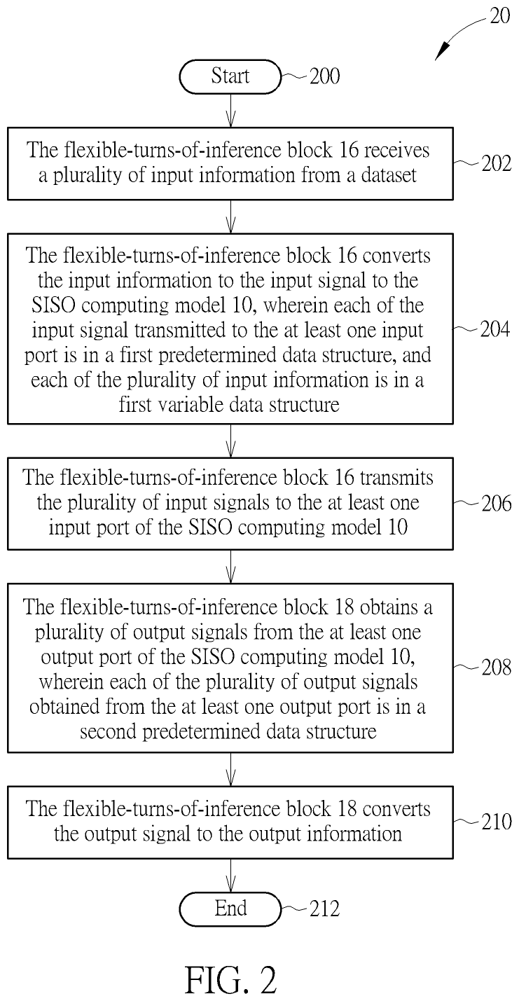

The above operations may be summarized into a control process 20, as shown in FIG. 2. The control process 20 comprises the following steps:

Step 200: Start.

Step 202: The flexible-turns-of-inference block 16 receives a plurality of input information from a dataset.

Step 204: The flexible-turns-of-inference block 16 converts the input information to the input signal to the SISO computing model 10, wherein each of the input signal transmitted to the at least one input port is in a first predetermined data structure, and each of the plurality of input information is in a first variable data structure.

Step 206: The flexible-turns-of-inference block 16 transmits the plurality of input signals to the at least one input port of the SISO computing model 10.

Step 208: The flexible-turns-of-inference block 18 obtains a plurality of output signals from the at least one output port of the SISO computing model 10, wherein each of the plurality of output signals obtained from the at least one output port is in a second predetermined data structure.

Step 210: The flexible-turns-of-inference block 18 converts the output signal to the output information.

Step 212: End

In other words, the embodiment of the present invention may convert fixed data structures of the input information and the output signal to the data structure fitting requirements of the SISO computing model 10. The detailed operations of the control process 20 may be referred to the foregoing description, which is not narrated herein for brevity. Moreover, the embodiment may further queue the input information and the output signal. For example, when a bus width of the training dataset is 128 bits and a bus width of the SISO computing model 10 is 64 bits, the embodiment may queue 2 input information and combine them into an input signal, which may increase the bus utilization efficiency and relieve the bus access latency to who use the training dataset as well.

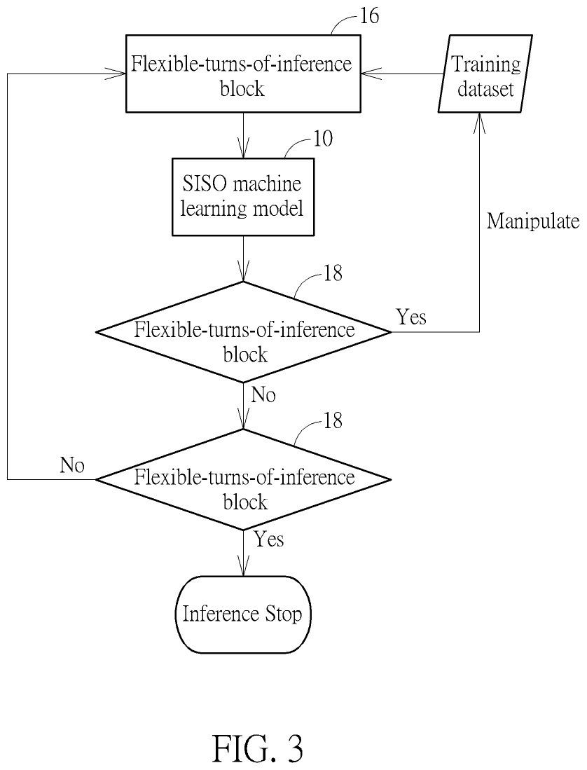

FIG. 3 is a schematic diagram of another control method for the SISO computing model 10 training according to an embodiment of the present invention. FIG. 3 is derived from FIG. 1, such that the same elements are denoted by the same symbols. In FIG. 3, at least one auxiliary node is added when the inference method starts, while none or some of the at least one auxiliary node is removed when the inference method ends. The at least one auxiliary node is configured to determine whether the training needs to stop or not. For example, the chatbot may determine whether to send the message according to auxiliary node.

As mention above, the dataset may be removed after training such that the SISO computing model 10 may make the inference by itself. In other words, the input information 120 and output information 140 may be transmitted/received via the global I/O of the whole system

For example, a confidence node is added to indicate a confidence level of the SISO computing model 10 to avoid misjudging because the SISO computing model 10 may receive more redundant information. In an embodiment, the confidence node will have high value when the queued output signals fit the golden output information. In other words, the embodiment stops the training when the confidence level is larger than a threshold, and continues the training when the confidence level is less than the threshold. For another example, when overflow or divergence occurs in health test, or when the data is abnormal, the auxiliary node may output signal to let 18 convert to certain output information. The confidence node and the termination node may not only be used in training but also be applied to the inference. For example, when a chatbot received a message “Helloooooo” from a user, the chatbot may early terminate the receiving then start to respond with high confidence that the postfix “oo . . . ” may be a typo from the user. In an embodiment, the confidence node may be trained as well. In another embodiment, the confidence node is used to determine whether to execute the action represented by the node according to the calculation.

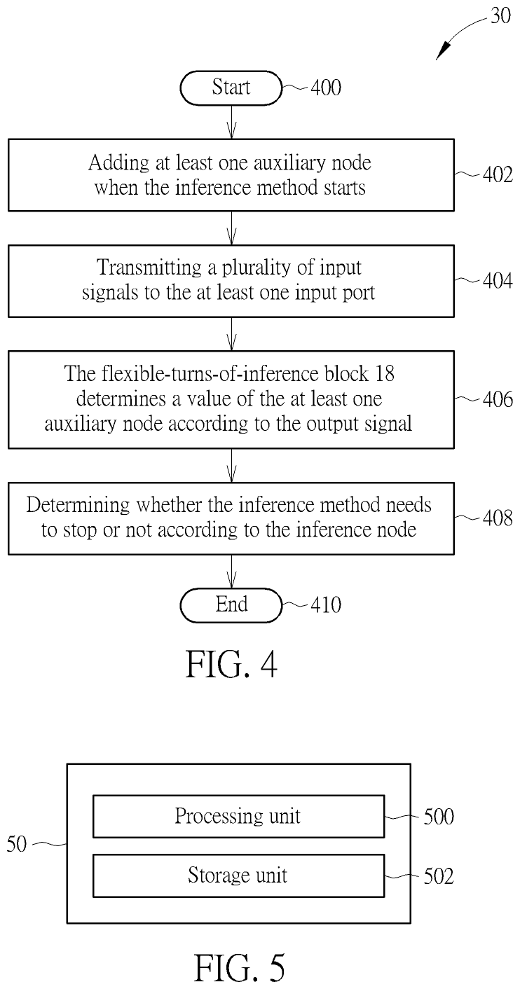

The above operations may be summarized into a control process 30, as shown in FIG. 4. The control process 30 comprises the following steps:

Step 400: Start.

Step 402: The control process 30 adds at least one auxiliary node when the inference method starts

Step 404: The flexible-turns-of-inference block 16 transmits a plurality of input signals to the at least one input port.

Step 406: The flexible-turns-of-inference block 18 determines a value of the at least one auxiliary node according to the output signal.

Step 408: The flexible-turns-of-inference block 18 determines whether the inference method needs to stop or not according to the auxiliary node.

Step 410: End

As can be seen, the flexible-turns-of-inference block 18 further controls the control process 30 according to the at least one auxiliary node. Therefore, the embodiment of the present invention may bypass to select an appropriate subset of the plurality of input information from the dataset to accelerate the operation in inference or in training; or the embodiment of the present invention may adjust the input information to an appropriate input signal in the inference. The detailed operations of the control process 30 may be referred to the foregoing description, which are not narrated herein for brevity.

In addition, the control process 20 and control process 30 may be implemented and/or executed by a computer system. For example, FIG. 5 is a schematic diagram of a computer system 50 according to an embodiment of the present invention. As shown in FIG. 5, the computer system 50 comprises a processing unit 500 and a storage unit 502. In an embodiment, each unit of the system 50 may be implemented by an application-specific integrated circuit (ASIC). In an embodiment, the processing unit 500 may be an application processor (AP) or a digital signal processor (DSP), wherein the processing unit 500 may be a central processing unit (CPU), a graphics processing unit (GPU) or a tensor processing unit (TPU) to implement the operation flow for the SISO computing model 10 mentioned above, and not limited thereto. The storage unit 502 may store a training dataset and a program code to instruct the processing unit 500 to perform the function of the control process 20 and control process 30 of the present invention. The storage unit 502 may be a ROM (Read-only Memory), a RAM (Random-access Memory), a CD-ROM, an Optical Data Storage Device), a Non-volatile Memory such as an electrically erasable programmable read-only memory (EEPROM) or a flash memory, and not limited thereto.

Notably, the embodiments stated in the above are utilized for illustrating the concept of the present application. Those skilled in the art may make modifications and alterations accordingly and not limited herein to fit the practical scenario. For example, the number of the input nodes may not be limited to the number of the output nodes. In an embodiment, the number of the inference input nodes, or the number of the output nodes may be 1; that is, the inference input information 120, the output signal 140 may be a scalar. In an embodiment, the data structures of the input information 120 and 122 may be different, so as to the data structures of golden output information 130 and 132. In another embodiment, the controller may be removed after training such that the SISO computing model 10 may make the inference by itself.

Moreover, those skilled in the art may also make modifications and alterations accordingly and not limited herein to the control process 30. For example, the input information 120 and the golden output information 130 are given from the dedicated I/O or general-purpose input/output (GPIO) instead of the dataset. In an embodiment, the number of auxiliary nodes may be 0 or 1 o or more; that is, the embodiment may control the process with/without the auxiliary nodes. In addition, the usage of auxiliary node is also not limited to control process termination or the confidence indication. For example, the added auxiliary nodes may be combined with existed auxiliary nodes which are contained by the SISO computing model 10. Therefore, as long as a control method capable of package single-input-single-output computing models into flexible-turns-of-inference algorithms, which make it possible to perform inference in a flexible number of turns and an interruptible manner, the requirements of the present application are satisfied and within the scope of the present application.

In summary, the present invention provides a control method and a computer system using the same, capable of package single-input-single-output computing models into flexible-turns-of-inference algorithms, which make it possible to perform inference in a flexible number of turns and an interruptible manner. With the flexible-turns-of-inference blocks and the auxiliary nodes, the SISO machine learning model may infer with the high efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method, applied to a single-input-single-output model, wherein at least one input port of the single-input-single-output model is configured to receive an input signal, and at least one output port of the single-input-single-output model is configured to transmit an output signal, the control method comprising:
receiving a plurality of input information from a dataset or an interface;
generating a plurality of input signals to the single-input-single-output model according to the plurality of input information;
transmitting the plurality of input signals to the at least one input port; and
obtaining a plurality of output signals from the at least one output port;
wherein each of the plurality of input signals transmitted to the at least one input port is in a first predetermined data structure, and each of the plurality of input information is in a first variable data structure;
wherein each of the plurality of output signals obtained from the at least one output port is in a second predetermined data structure.

2. The control method of claim 1, further comprising:
outputting a plurality of output information; and
adjusting or choosing an input information from the dataset or the interface to the control method according to the plurality of output information;
wherein each of the plurality of output information is in a second variable data structure.

3. The control method of claim 2, wherein adjusting or choosing the input information from the dataset or the interface to the control method according to the plurality of output information further comprises:
adjusting the input information from the dataset or the interface according to the plurality of output information and the plurality of input information.

4. The control method of claim 1, wherein generating the plurality of input signals to the single-input-single-output model according to the plurality of input information further comprises:
generating the plurality of input signals to the single-input-single-output model according to the plurality of output signals and the plurality of input information.

5. The control method of claim 1, further comprising determining whether the control method needs to stop or not according to an inference method.

6. An inference method, applied to a single-input-single-output model, wherein at least one input port of the single-input-single-output model is configured to receive an input signal, and at least one output port of the single-input-single-output model is configured to transmit an output signal, the inference method comprising:
adding at least one auxiliary node when the inference method starts;
transmitting a plurality of input signals to the at least one input port;
determining a value of the at least one auxiliary node according to the output signal; and
determining whether the inference method needs to stop or not according to the auxiliary node;
wherein the output signal transmitted from the at least one output port is in a first variable data structure;
wherein each of the plurality of input signals transmitted to the at least one input port is in a second variable data structure.

7. The inference method of claim 6, further comprising adjusting the plurality of input signals to the at least one input port according to the value of the at least one auxiliary node.

8. The inference method of claim 6, wherein determining the value of the at least one auxiliary node according to the output signal further comprises determining the value of the at least one auxiliary node according to the output signal and the plurality of input signals.

9. The inference method of claim 6, wherein determining whether the inference method needs to stop or not according to the inference node further comprises:
stopping the inference method when the value is larger than a threshold; and
continuing the inference method when the value is less than the threshold.

10. The inference method of claim 6, further comprising removing the at least one auxiliary node when the inference method ends.

11. A computer system, applied to a single-input-single-output model, wherein at least one input port of the single-input-single-output model is configured to receive an input signal, and at least one output port of the single-input-single-output model is configured to transmit an output signal, comprising:
a processing unit; and
a storage unit, storing a program code, wherein the program code instructs the processing unit to execute the following steps:
receiving a plurality of input information from a dataset or an interface;
generating a plurality of input signals to the single-input-single-output model according to the plurality of input information;
transmitting the plurality of input signals to the at least one input port; and
obtaining a plurality of output signals from the at least one output port;
wherein each of the plurality of input signals transmitted to the at least one input port is in a first predetermined data structure, and each of the plurality of input information is in a first variable data structure;
wherein each of the plurality of output signals obtained from the at least one output port is in a second predetermined data structure.

12. The computer system of claim 11, wherein the program code further instructs the processing unit to execute:
outputting a plurality of output information; and
adjusting or choosing an input information from the dataset or the interface to the control method according to the plurality of output information;
wherein each of the plurality of output information is in a second variable data structure.

13. The computer system of claim 12, wherein adjusting or choosing the input information from the dataset or the interface to the control method according to the plurality of output information further comprises:
adjusting the input information from the dataset or the interface according to the plurality of output information and the plurality of input information.

14. The computer system of claim 11, wherein generating the plurality of input signal to the single-input-single-output model according to the plurality of input information further comprises:
generating the plurality of input signals to the single-input-single-output model according to the plurality of output signals and the plurality of input information.

15. The computer system of claim 11, wherein the program code further instructs the processing unit to execute determining whether the control method needs to stop or not according to an inference method.

16. A computer system for an inference method, applied to a single-input-single-output model, wherein at least one input port of the single-input-single-output model is configured to receive an input signal, and at least one output port of the single-input-single-output model is configured to transmit an output signal, comprising:
a processing unit; and
a storage unit, storing a program code, wherein the program code instructs the processing unit to execute the following steps:
adding an auxiliary node when the inference method starts;
transmitting a plurality of input signals to the at least one input port;
determining a value of the at least one auxiliary node according to the output signal; and
determining whether the inference method needs to stop or not according to the auxiliary node;
wherein the output signal transmitted from the at least one output port is in a first variable data structure;
wherein each of the plurality of input signals transmitted to the at least one input port is in a second variable data structure.

17. The computer system of claim 16, wherein the program code further instructs the processing unit to execute adjusting the plurality of input signals to the at least one input port according to the value of the at least one auxiliary node.

18. The computer system of claim 16, wherein determining the value of the at least one auxiliary node according to the output signal further comprises determining the value of the at least one auxiliary node according to the output signal and the plurality of input signals.

19. The computer system of claim 16, wherein determining whether the inference method needs to stop or not according to the inference node further comprises:
stopping the inference method when the value is larger than a threshold; and
continuing the inference method when the value is less than the threshold.

20. The computer system of claim 16, wherein the program code further instructs the processing unit to execute removing some of the at least one auxiliary node when the inference method ends.
